(19) United States
(12) Patent Application Publication
(10) Pub. No.: US 2015/0227404 A1
(43) Pub. Date: Aug. 13, 2015

(54) SYSTEMS AND METHODS FOR SMART SERVICE MANAGEMENT IN A MEDIA NETWORK

(71) Applicants: Harish Nair Rajagopal, Trivandrum (IN); Gowrishankar Subramaniam Natarajan, Chennai (IN)

(72) Inventors: Harish Nair Rajagopal, Trivandrum (IN); Gowrishankar Subramaniam Natarajan, Chennai (IN)

(73) Assignee: WIPRO LIMITED, Bangalore (IN)

(21) Appl. No.: 14/228,827

(22) Filed: Mar. 28, 2014

(30) Foreign Application Priority Data
Feb. 11, 2014 (IN) 647/CHE/2014

(51) Int. Cl. G06F 11/07

(52) U.S. Cl. CPC G06F 11/079

(57) ABSTRACT

This disclosure relates generally to network service management, and more particularly to systems and methods for smart service management in a media network. In one embodiment, a smart diagnostic system is disclosed, comprising: a hardware processor; and a memory storing processor-executable instructions comprising instructions for: receiving an agent fault report, including one or more network-wide standardized fault codes, from an agent application executing on a remote device in a media network; aggregating one or more relevant fault reports related to the agent fault report; obtaining one or more fault classification rules; identifying one or more fault nodes and associated fault conditions in the media network using the one or more fault classification rules, by analyzing the aggregated relevant fault reports; and providing an agent configuration instruction for one or more agent applications using the identification of the one or more fault nodes and associated fault conditions.

### PRIORITY CLAIM

This U.S. patent application claims priority under 35 U.S.C. §119 to Indian Patent Application No. 647/CHE/2014, filed Feb. 11, 2014, and entitled “SYSTEMS AND METHODS FOR SMART SERVICE MANAGEMENT IN A MEDIA NETWORK.” The aforementioned application is incorporated herein by reference in its entirety.

### TECHNICAL FIELD

This disclosure relates generally to network service management, and more particularly to systems and methods for smart service management in a media network.

### BACKGROUND

The media delivery chain required to deliver video and interactive services for managed devices has evolved in recent years to become a highly complex infrastructure. In a media service delivery context, multiple parties may be involved in the entire service chain. For example, the service chain may comprise content providers, broadcasters, Pay-TV service providers (PTVSP), network providers, etc. Faults may occur anywhere in the service chain. For example, an isolated fault may be detected in a node of the network, causing a particular type of service disruption for a set of end-users. In other cases, multiple isolated faults may be detected that simultaneously affect a set of end-users. Sometimes, even though there is an isolated fault, it has no impact on any end-user. In some cases, faults that affect end-users may not be reported, even though there is a service disruption. Fault detection and remediation can therefore be a complex and costly endeavor.

### SUMMARY

In one embodiment, a smart diagnostic system is disclosed, comprising: a hardware processor; and a memory storing processor-executable instructions comprising instructions for: receiving an agent fault report, including one or more network-wide standardized fault codes, from an agent application executing on a remote device in a media network; aggregating one or more relevant fault reports related to the agent fault report; obtaining one or more fault classification rules; identifying one or more fault nodes and associated fault conditions in the media network using the one or more fault classification rules, by analyzing the aggregated relevant fault reports; and providing an agent configuration instruction for one or more agent applications using the identification of the one or more fault nodes and associated fault conditions.

In one embodiment, a smart diagnostic method is disclosed, comprising: receiving an agent fault report, including one or more network-wide standardized fault codes, from an agent application executing on a remote device in a media network; aggregating one or more relevant fault reports related to the agent fault report; obtaining one or more fault classification rules; identifying, via a hardware processor, one or more fault nodes and associated fault conditions in the media network using the one or more fault classification rules, by analyzing the aggregated relevant fault reports; and providing an agent configuration instruction for one or more agent applications using the identification of the one or more fault nodes and associated fault conditions.

In one embodiment, a non-transitory computer-readable medium is disclosed, storing computer-executable smart diagnostic system instruction comprising instructions for: receiving an agent fault report, including one or more network-wide standardized fault codes, from an agent application executing on a remote device in a media network; aggregating one or more relevant fault reports related to the agent fault report; obtaining one or more fault classification rules; identifying one or more fault nodes and associated fault conditions in the media network using the one or more fault classification rules, by analyzing the aggregated relevant fault reports; and providing an agent configuration instruction for one or more agent applications using the identification of the one or more fault nodes and associated fault conditions.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIGS. 1A-C illustrate exemplary aspects of a smart service management system;

FIG. 2 illustrates components of a smart service management system for a media network;

FIG. 3 is a block diagram depicting smart service management in a media network service chain;

FIG. 4A is a block diagram of components of a smart service management system;

FIG. 4B is a flowchart of a smart service management procedure;

FIGS. 5A-C are screenshots of a user interface for fault detection and remediation in a smart service management system;

FIGS. 6A-C are flowcharts of a fault reporting procedure for smart service management;

FIGS. 7A-C are flowcharts of a server-side fault remediation procedure for smart service management;

FIG. 8 is a flowchart of an agent-side fault remediation procedure for smart service management;

FIGS. 9A-B are flowcharts of a fault classification learning procedure for smart service management;

FIG. 10 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

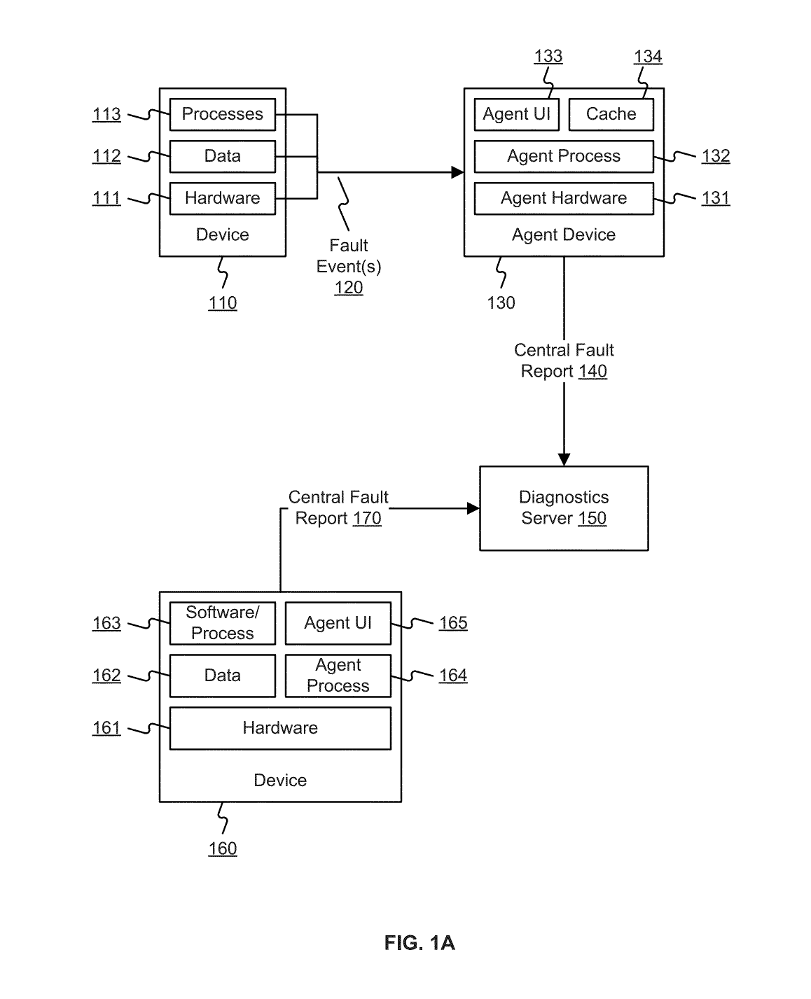

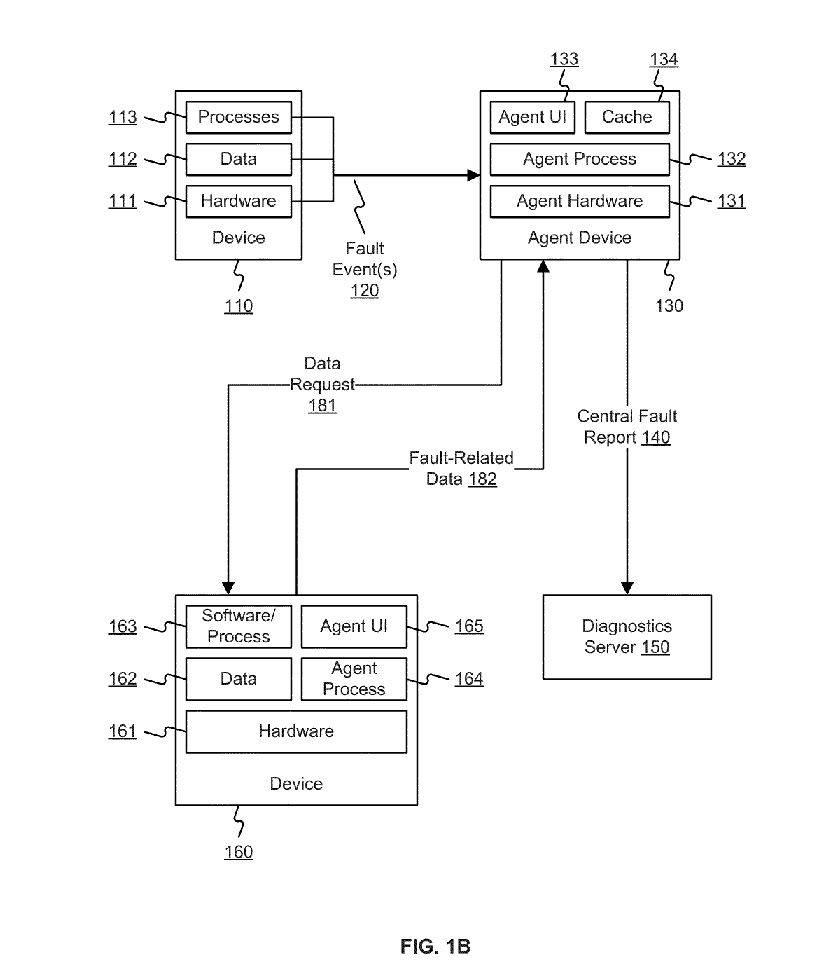

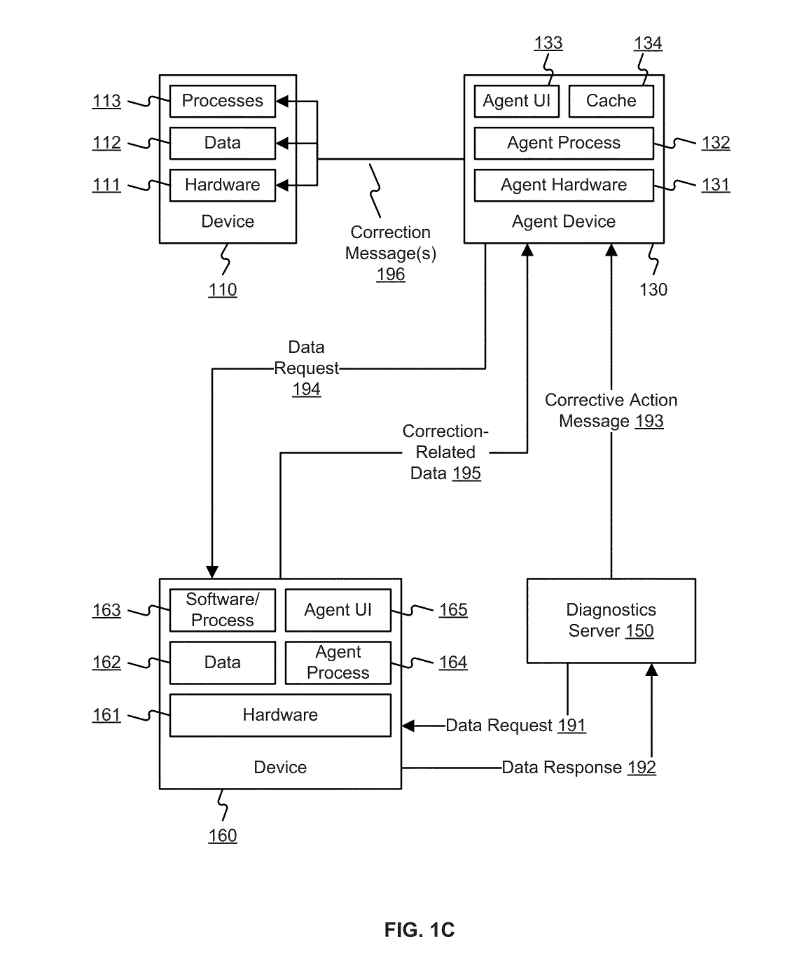

FIGS. 1A-C illustrate exemplary aspects of a smart service management system. With reference to FIG. 1A, in some embodiments, a device 110 may comprise hardware 111, storing data 112, and executing process 113. In the event of a fault identified by device 110 in either the hardware 111, data 112, or process 113, device 110 may report a fault event 120 to an agent. The agent may take the form of an agent device 130 separate from device 110, which comprises agent hardware 131, running agent process 132. In some embodiments, agent device 130 may provide an agent user interface (UI) 133 via which statistics, reports, logs, activity, etc. of the agent device 130 may be visualized. Agent device may also include a cache 134 to queue central fault reports 140 to be sent to a diagnostics server 150.

In some embodiments, the agent may not be embodies as a device separate from the device reporting the local fault, but may be implemented as part of the device. For example, a device 160 may comprise hardware 161, storing data 162, and executing processes 163. Hardware 161 may also be used to execute an agent process 164 and an agent UI 165. Using agent process 164, device 160 may report faults in the form of a central fault report 170 to diagnostics server 150.

With reference to FIG. 1B, in some embodiments, before agent device 130 can report a fault to diagnostics server 150, agent device 130 may collect information (e.g., “local context”) to be reported as part of central fault report 140. For example, agent device 130 may make a data request 181 to another agent (e.g., agent process 164) or device (e.g., device 160) for fault-related data 182. Upon obtaining fault-related data 182, agent device 130 may generate the central fault report 140, and provide it to diagnostics server 150 for fault detection and remediation.

With reference to FIG. 1C, in some embodiments, diagnostics server 150 may attempt to identify faults in a network of devices, applications, and services. Before diagnostics server 150 can identify a fault and appropriate remediation actions, diagnostics server 150 may collect information (e.g., “global context”) for analysis. For example, diagnostics server 150 may make a data request 191 to an agent (e.g., agent process 164) or device (e.g., device 160) for data response 192. Upon obtaining data response 192, diagnostics server 150 may identify remediation actions, and generate corrective action message 193 for agent device 130. Agent device 130, in some embodiments, may determine that additional information is needed before the corrective action can be implemented, and may make a data request 194 (e.g., to an agent to device) for the correction-related data 195. Upon obtaining correction-related data 195, agent device 130 may generate a correction message 196 for device 110 with instructions to remedy the identified fault. In some embodiments, agents may convert all information obtained “locally” into a standardized format, e.g., using standardized global codes such as error codes, before communicating the information to other agents, devices, or diagnostics server 150.

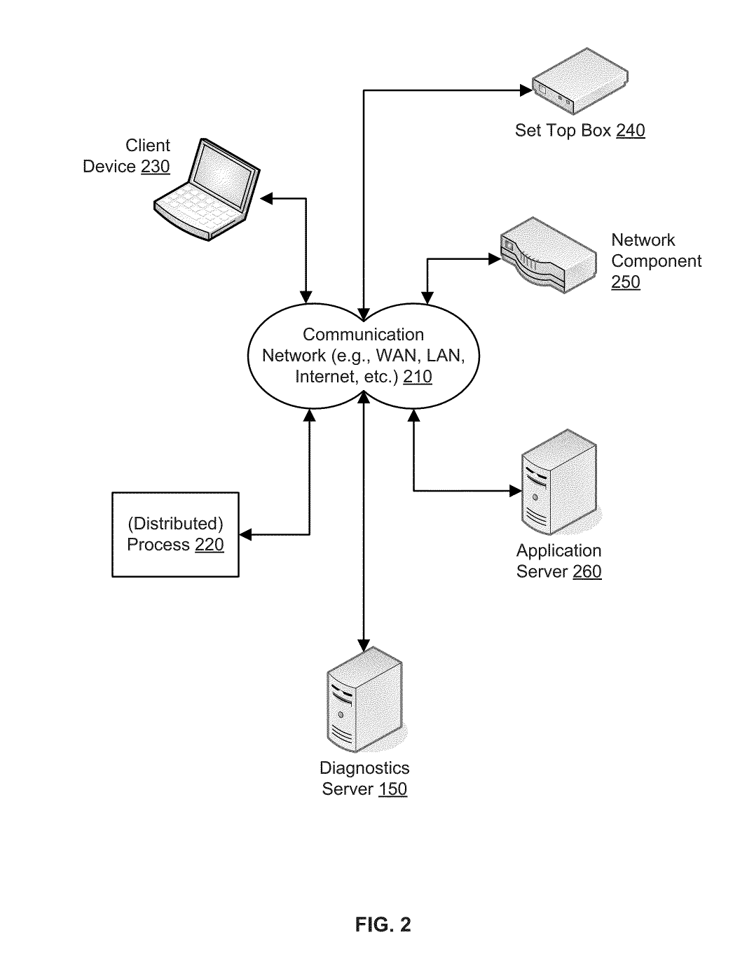

FIG. 2 illustrates components of a smart service management system for a media network. Example components in which a fault may occur include a client device 230 (e.g., desktop computer, laptop computer, smartphone, cellular phone, modem, home routers, switch, television, etc.), set top box 240, network components 250 (e.g., servers, gateways, routers, bridges, etc.), application servers 260, and even processes 220. In some scenarios, processes 220 may comprise a distributed process that is implemented across a large numbers of devices. Also, any data stored on any of these devices, or manipulated by any of these “nodes” may also be considered a node where a fault can occur. All such “nodes” may communicate with diagnostics server 150 via communication network 210 (e.g., a wide/local area network, wireless network, cellular network, Internet, or combinations thereof).

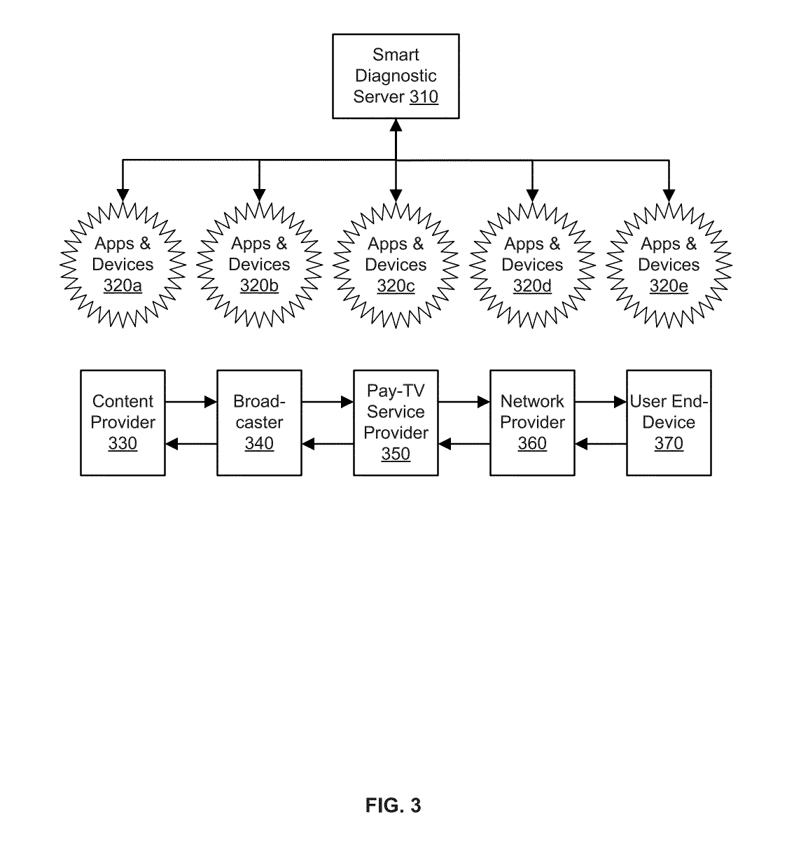

FIG. 3 is a block diagram depicting smart service management in a media network service chain. In one embodiment, smart service management may be applied for fault detection and remediation in a media content delivery network. For example, the network may comprise a user end-device 370 (e.g., television, set top box, computer, smartphone, etc.) that displays content media for a user. A content provider 330 (e.g., production house) may generate media content, and a broadcaster 340 may broadcast the content via a distribution network. As part of the distribution network, a Pay-TV service provider 350 may provide on-demand TV services for the end-user via a network maintained by a network provider 360. Each of these entities may utilize one or more applications (“apps”) and/or devices (see 320a-e) to provide its features. These apps and/or devices 320a-e may interact, via one or more smart agents, with a smart diagnostic server 310. For example, the apps and/or devices 320a-e may report faults and/or other information to the smart diagnostic server 310, and may implement remediation actions as recommended or instructed by the smart diagnostic server 310.

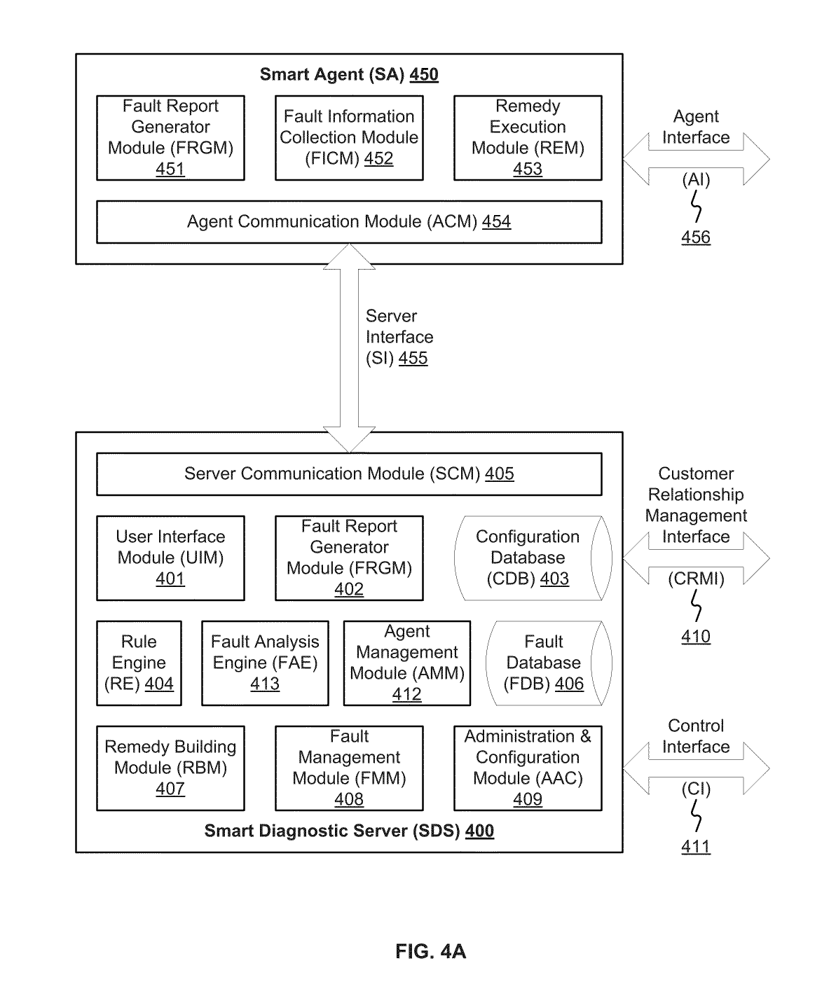

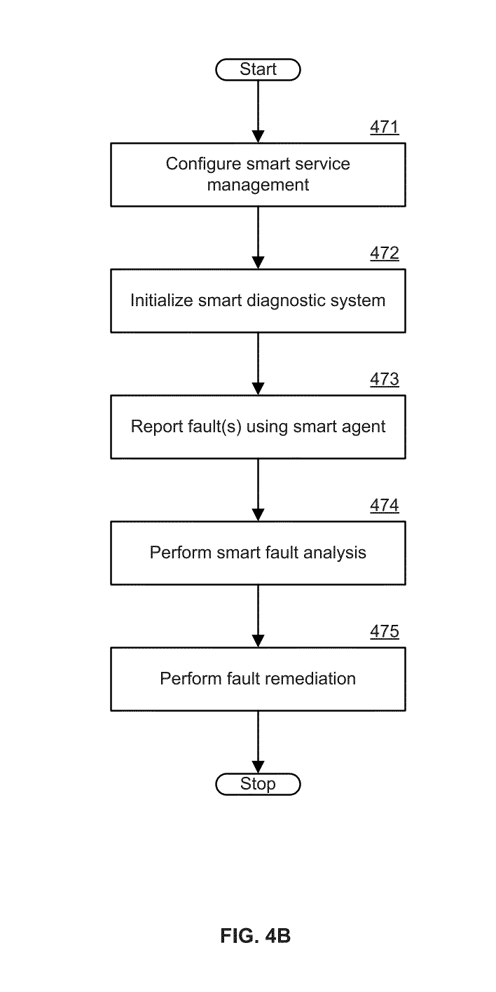

FIG. 4A is a block diagram of components of a smart service management system. In one embodiment, a smart service management system may include one or more smart agents (SA) 450, interacting with one or more smart diagnostic servers (SDS) 400. SDS 400 may include a server communication module (SCM) 405. SCM 405 may provide communication with SA 450 via server interface (SI) 455. SI 455 may serve as an interface between SA 450 and SDS 400. SI 455 may support push mode from SA 450 to push fault report to SDS 400, and/or pull mode from SDS 400 to pull reports from SA 450. SI 455 may provide support for configuration of SAs 450 based on fault definitions specified in SDS 400. SI 455 may also support communication between SAs 450 to exchange information.

SCM 405 may also provide communication with a customer relationship management (CRM) system (not shown) over a customer relationship management interface (CRMI) 410, and with a control system via control interface (CI) 411. CRMI 410 may serve as an interface between CRM system and SDS 400, and may facilitate associating customer reported problems with rules. CI 411 may provide a control interface to SDS 400 for configuring/administering from external applications. CI 411 may also facilitate providing views of existing system fault statistics and performance via user interface module (UIM) 401, and allow modification of rules/remedies within SDS 400 via UIM 401.

SDS 400 may include an administration and configuration module (AAC) 409. AAC 409 may provide administrative capabilities for adding/deleting/managing users of the smart management service. AAC 409 may provide administrative capabilities for setting permissions for users of the smart diagnostic service. AAC 409 may also provide a configuration view to authorized users for configuring Rule Charts that link faults and remedies for use by Rule Engine (RE) 404.

SDS 400 may include a user interface module (UIM) 401. UIM 401 may provide a user interface to users of SDS 400 for general system configuration and administration. UIM 401 may provide a user interface to users of SDS 400 for viewing statistics and rule/remedy suggestions.

SDS 400 may include a fault database (FDB) 406. FDB 406 may serve as a database for storing fault schema related information. For example, FDB 406 may store fault reports from SA 450, and logs and results of remedies that are triggered by SDS 400. FDB 406 may also store configured rules that are generated by authorized users via AAC 409 for use by RE 404. Also, FDB 406 may store remedies that need to be triggered by rules.

SDS 400 may include a configuration database (CDB) 403. CDB 403 may store the configuration parameters of SDS 400, including user/administrator details, permissions for each user using SDS 400 for configuring rules, fault mappings, accessing fault information, system views and general house keeping.

CDB 403 may also store mapping information of local (device/system) specific error codes and messages to central error codes and messages, in order to create a system-wide set of standardized error codes that can used across entities and components within a complex service chain. CDB 403 may store a global fault map, which maps local fault codes (LFC) generated by system components to a unique central fault code (CFC), based on the sub-system/application/service/device component that generated the local fault. Associated with the central fault code, CDB 403 may also store an error type, error severity, and local fault code. CDB 403 may also store a fault classification map, which maps the unique central fault code to a service chain-based fault type and sub-type. CDB 403 may further store a fault investigation map, which maps the fault type and fault sub-type from the fault classification map with the associated local and global context information that is collected. Moreover, CDB 403 may store a fault scenario map, which maps the fault scenarios to be monitored. AAC 409 may obtain the fault scenarios based on inputs from the Administrator/Engineer and from fault analysis engine (FAE) 405. Each fault scenario may comprise a list of fault groupings, including such properties as: fault property type (instance, occurrence, persistence); fault window (time window in which fault happened); fault recurrence (repetitions in time window); fault relation (logical relationship to system components); and fault grouping (family/group of faults linking to other faults in the same fault scenario).

SDS 400 may include a Rule Engine (RE) 404. RE 404 may evaluate the rules configured by AAC 409 when fault reports are received from SA 450. RE 404 may use fault management module (FMM) 408 to identify whether rule conditions are met, and trigger remedies when any rule configured is evaluated as true.

SDS 400 may include a remedy building module (RBM) 407. RBM 407 may build and suggest remedies based on existing remedies configured via AAC 409. RBM 407 may also evaluate effectiveness of configured remedies and suggest improvements.

SDS 400 may include a fault management module (FMM) 408. FMM 408 may set up and manage fault nodes based on a rule chart configured by the user. Each node in FMM 408 may represent a fault configured as part of the rule chart and its associated conditions. In some embodiments, FMM 408 may be configured to eliminate duplicate nodes for the same fault in different rules. FMM 408 may update node information based on the fault reports provided by SA 450, and notifies fault analysis engine (FAE) 405 on arrival of a fault report.

SDS 400 may include a Fault Analysis Engine (FAE) 405. FAE 413 may analyze fault conditions based on the fault nodes set up by FMM 408, and trigger relevant rules for evaluation by the RE 404. FAE 413 may also suggest new rules or modifications to existing rules for increased effectiveness in fault correction.

SDS 400 may include an agent management module (AMM) 412. AMM 412 may manage different SAs 450 that are there in the system. AMM 412 may allows SAs 450 to look up other SAs for requesting and gathering contextual information.

SDS 400 may interact with smart agent (SA) 450. SA 450 may include an agent communication module (ACM) 454. ACM 454 may handle communications between SA 450 and SDS 400 via SI 455. ACM 454 may also facilitate communication for configuring SA 450 from SDS 400. SA 450 may include a fault report generator module (FRGM) 451. FRGM 451 may generate fault reports for passing to SDS 400 based on fault incident reported from fault information collection module (FICM) 452. FRGM 451 may format fault reports for passing to SDS 400 with format as defined by SDS 400. FRGM 451 may also add contextual information for passing to SDS 400 with format as defined by SDS 400. FRGM 451 may determine if any additional information needs to be collected for complete fault report generation, and may use the FICM 452 to collect additional contextual information as required for a fault incident.

SA 450 may include a fault information collector module (FICM) 452. FICM 452 may collect fault information that is reported via agent interface (AI) 456 from clients, user devices, etc. FICM 452 may collect additional information requested by the FRGM 451 via AI 456 from clients, user devices, etc. FICM 452 may also maintain a local copy of the fault information. SA 450 may also include a remedy execution module (REM) 453. REM 452 may execute remedies specified by SDS 400, e.g., when triggered by SDS 400, and may send execution report and logs back to SDS 400.

FIG. 4B is a flowchart of a smart service management procedure. At step 471, SDS 400 may configure the smart service management. SDS 400 may first perform a standard configuration. Standard configuration may involve network configuration of services, devices, and apps. SDS 400 may discover network topology (e.g., nodes, channels, actors, connectivity, and classification) using standard auto discovery methods. If needed, AAC 409 may further modify auto-discovered network configurations based on inputs from authorized person (e.g., a network administrator). SDS 400 may identify node configuration for devices, other servers, and application/services using standard access mechanisms and protocols. If needed, AAC 409 may be used to modify the node configuration using inputs from an authorized person. SDS 400 may also perform service configuration as part of the standard configuration (e.g., configuration service specifications for each type of services end-user). AAC 409 may obtain service definition through SCM 405, e.g., using a standard web-service interface like XML, UDDI, etc., or based on inputs from an authorized person.

Next, SDS 400 may perform agent configuration. SDS 400 may assign each SA 450 a globally unique ID that is generated by AAC 409 using the identity of the host (e.g., MAC address) and target application (e.g., unique name of the application). In case SA 450 is associated with a device, the agent ID may be generated using the device ID. SA 450 may configure connectivity and communication protocols for AI 456 by ACM 454 using standard discovery mechanisms. SDS 400 may configure interfaces by AAC 409 using standard discovery mechanisms, and can be updated based on AAC configuration done by an authorized Person. Interface configuration may include agent interface configuration and server interface configuration. SDS 400 may configure the behavior of SA 450 in case of fault reception and reporting by AAC 409 through SCM 405 and SI 455. A local copy of agent configuration may be provided to SA 450 during this process. AAC 409 may select a portion of the fault classification map relevant for SA 450 and create a local copy for SA 450. AAC 409 may also select a portion of the fault investigation map relevant for SA 450 and create a local copy for SA 450.

SDS 400 may generate a mapping between the service chain and the system landscape. First, SDS 400 may perform a system landscape mapping. AAC 409 may use the standard configuration information (e.g., network topology, node-configuration information) to establish relationships among nodes (devices/servers/applications) to form a system landscape. AAC 409 may define a service chain using the service configuration to establish relationships between end-user services and underlying services.

AAC 409 may then perform service chain-to-system landscape mapping. AAC 409 may load manual configuration information provided by an authorized person, and obtain information about the association between services and corresponding applications/devices. AAC 409 may then obtain information for an authorized person, using UIM 401 and CI 411, to configure the global fault map, fault classification map, and fault investigation map. These maps may be stored in CDB 403.

AAC 409 may use service-chain information, service-association information, and the system landscape information to produce a service chain-to-system landscape mapping using FAE 413. Specifically, FAE 413 may use centralized fault codes from the global fault map, and fault types and subtypes from the fault classification map, to identify relationships between system components and service chain components.

FAE 413 may establish links between service chain components and other system components based on the fault investigation map, by mapping between context information in the fault investigation map and service chain components. AAC 409 may use these links for (de)linking faults in fault groupings for the fault scenario map. When SA 450 reports a fault that is not yet mapped to a service chain, FAE 413 may analyze the local fault and, based on previous associations, propose new links to an authorized user for linking or delinking faults in the fault groupings for the fault scenario map.

In addition, AAC 409 may obtain mapping between fault codes (central fault and local fault) in standard form (XML, CSV for example) in specified format through SCM 405. AAC 409 may further modify the mapping based on inputs from an authorized person. AAC 409 may obtain a list of central fault codes and a corresponding list of known remedies for each of the central fault codes, e.g., as provided by an authorized person. AAC 409 may obtain the fault scenario map based on inputs from an authorized person, and from FAE 413 in the form of fault groupings with properties such as: fault property type (instance, occurrence, persistence); fault window (time window in which fault happened); fault recurrence (repetitions in time window); fault relation; fault grouping; etc. AAC 409 may obtain the fault investigation map based on inputs from an authorized person that maps fault types and fault sub-types with associated local and global context information. The global fault map may define the fault types and sub-types. Local and global context information may be obtained from the standard configuration discussed earlier. All data generated through the above configuration steps may be stored in CDB 403.

At step 472, SDS 400 may initialize the smart diagnostic system. AAC 409 may load the global fault map, fault classification map, fault investigation map, and fault scenario map, as well as the standard-configuration, service-chain information, system-landscape mapping information from CDB 403 to a memory accessible to SDS 400. SA 450 may register with AMM 412 at start-up via ACM 454 through SI 455, by sending control messages along with its own unique ID. During registration, SA 450 may inform SDS 400 about the applications, services, and/or devices that it supports. AMM 412 may maintain the mapping between applications, services, and/or devices and SA 450 that provides the information. SDS 400 may provide relevant information about other smart agents to SA 450, e.g., to facilitate communication between smart agents.

At step 473, a user device, client, etc. may use SA 450 to report a fault to SDS 400. SA 450 may receive the fault notification through FICM 452 and AI 456. SA 450 may use a procedure for gathering all information relevant to the fault notification (e.g., local fault context from the device, service, and/or application) through AI 456, and FRGM 451 may generate a central fault record. FICM 452 may collect a local fault report from the user device, client, etc., and provide it to FRGM 451. FRGM 451 may parse the local fault report, and reads the local fault code from the local fault report. FRGM 451 may use the local fault code to find the appropriate centralized fault code from SA 450 local copy of the global fault map stored in local memory of the FRGM. If an appropriate centralized fault code is not found, FRGM 451 may assign a default centralized fault code corresponding to the local fault code. FRGM 451 may then create a central fault record with the local fault report and the corresponding centralized fault code. FRGM 451 may include in the central fault record a fault type and fault subtype based on the local copy of fault reclassification map stored in FRGM 451 that holds the mapping of centralized fault code to service fault type and subtype.

In some embodiments, FRGM 451 may find associations to other services/applications/devices for the fault type and sub-type classification from the local copy of the fault classification map previously stored in local memory of FRGM 451. Based on the association list, SA 455 may find the global information that needs to be fetched via other SAs. In case information is required from other SAs, the requesting SA 450 may look up the corresponding SA that services the identified service/application/device from AMM 412 at SDS 400, and issue a request to the SAs either directly using FRGM 451 or via proxy through AMM 412. After the requested information is received from the other SAs, FRGM 451 may add the information to the central fault record.

FRGM 451 may also find associations to local information required for the fault type and fault subtype from the local copy of fault classification map previously stored in local memory of FRGM 451. SA 450 may use these associations to collect information via FICM 452 and store the information in the central fault record. SA 450 may then report the central fault record to SDS 400, using ACM 454 through SI 455. At SDS 400, FMM 408 may receive the central fault report, and store a copy of the central fault report in FDB 406.

At step 474, SDS 400 may perform smart fault analysis. When SDS 400 receives a central fault report from SA 455, SDS 400 may perform service fault segregation to identify one or more fault nodes where a fault may have occurred, and rules to be executed by RE 404 to identify remediation measures. SDS 400 may use service chain information and other received service faults to identify the nodes. In particular, SDS 400 may be able to identify dependencies between central fault records submitted by different SAs. For example, a fault in one node (e.g., a device, application, etc.) may cause several SAs linked to nodes with which the faulty node communicates to generate and send central fault records. SDS 400 may use the segregation procedure to identify the faulty node based on the multiple central fault records from the multiple linked SAs.

When a central fault record is received via SI 455 and SCM 405, the FMM 408 identifies the corresponding fault node (as reflected in the central fault record) in the fault scenario map, and triggers FAE 413 for fault analysis related to the specified node. When a service fault is reported (e.g., by a user) via CRMI 410 and SCM 405, FAE 413 may use the fault classification map to identify the service chain component at issue. FAE 413 may identify fault nodes that are part of the service chain component in the fault scenario map. FAE 413 then performs fault scenario identification. FAE 413 may analyze the edges (e.g., communication links) associated with the triggered node(s) that satisfies edge conditions, and thereby attempts to identify an origin node of the fault scenarios that are linked. In the example above where a fault in one node causes several SAs linked to nodes with which the faulty node communicates to send central fault records, all nodes may be included in the fault scenario map, and FAE 413 may identify the faulty node as the origin node. When service faults are reported through CRMI 410, FAE 413 may also isolate clusters of nodes as suggestible scenarios, with identifiers such as: nodes evaluated to be true (for persistent faults); nodes evaluated to be true in the recent time window between service faults (for transient and recurring faults); nodes historically associated together; fault scenario evaluation, etc. FAE 413 may evaluate the identified fault scenarios via edges from the origin node of the scenarios to determine if the fault scenario is satisfied. In case the FAE determines any fault scenario(s) to be satisfied, the corresponding remediation rule may be triggered at RE 404. AAC 409 may store suggestible scenarios in the fault scenario map to be used for building recommendations to the authorized user using UIM 401.

At step 475, SDS 400 may perform fault remediation in conjunction with SA 450. RBM 407 may build an appropriate remedy from a list of remedies corresponding to a given satisfied fault scenario. In case of no known remedies, RBM 407 may suggest the nearest remedy or remedies that can be used to solve a fault scenario using analysis of remedy characteristics and previous history of association with fault scenario signatures. An authorized user can add new remedies through UIM 401 and AAC 409.

AAC 409 may build a rule chart that links the fault scenarios to one or more of the remedies. Remedies/Corrections associated with fault scenarios will also have interdependency among themselves, such as sequential, parallel, conditional executions in different combinations. The remedies chosen will carry forward these characteristics and allow only chaining or grouping of remedies that satisfy these conditions. RBM 407 may use these characteristics when suggesting remedies for fault scenarios, based on previous associations between remedy characteristics and fault scenario signatures. When RE 404 evaluates a rule as true, the remedies corresponding to that rule may be executed via SA 455.

RBM 407 may analyze logs of the remedies and the faults of the fault scenario that was evaluated for the rule to determine the effectiveness of remedy. RBM 407 may flag in-effective remedies and quantitative ineffectiveness based on this analysis. RBM 407 may also suggest further improvements to a remedy based on characteristics of current remedy, other remedies in database and successful historical association with other fault scenarios to the service provider who defines the rule chart.

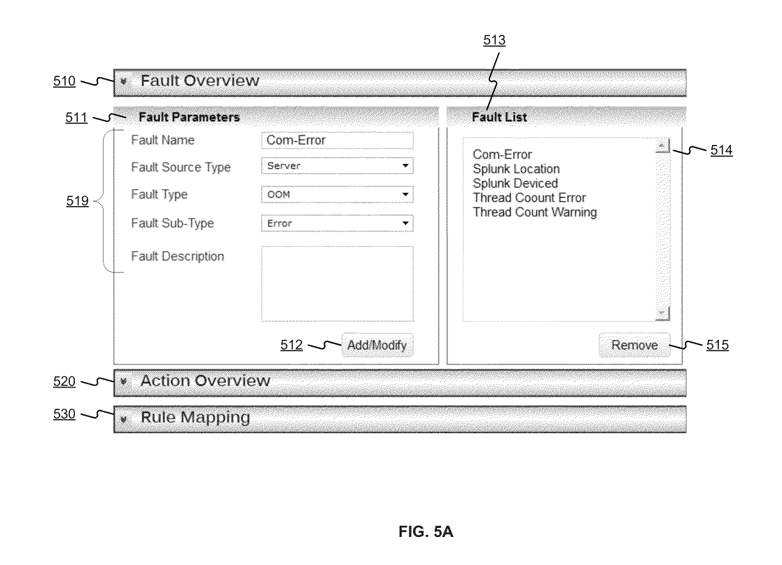

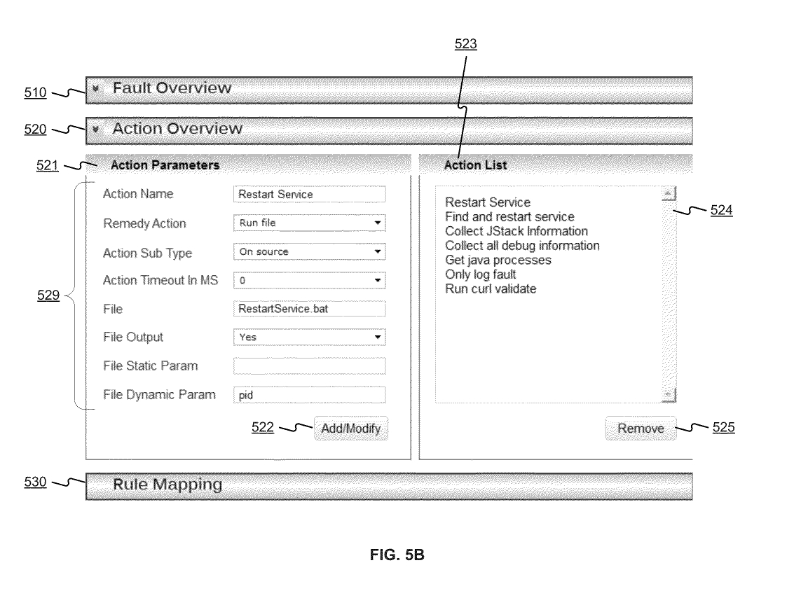

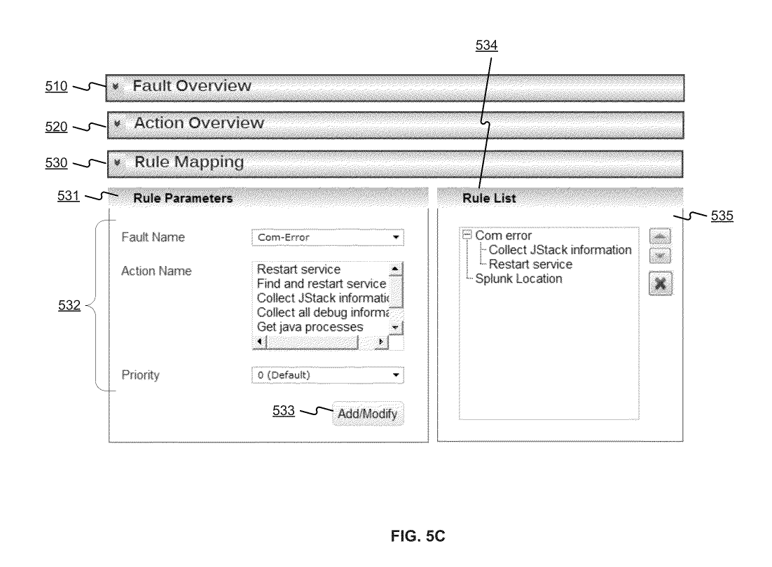

FIGS. 5A-C are screenshots of a user interface for fault detection and remediation in a smart service management system. With reference to FIG. 5A, a “faults” user interface screen (UI) may be provided by UIM 401 or by agent UIs 134, 165. The screen may include a list of faults identified 513 at the site (e.g., SA 450, SDS 400). A user may be able to scroll through the list using user interface elements 514, and may be able to modify the list using additional user interface elements 515. Each identified fault in the fault list 513 may have associated with it a number of fault parameters 511. Examples of such fault parameters include: fault name; fault source type; fault type; fault sub-type; fault description; etc. (see 519). A user may be able to modify parameters associated with an identified fault using user interface elements 512. Additionally, a user may be able to view an “actions” UI and a “rules” UI using user interface elements 520 and 530, respectively.

With reference to FIG. 5B, an “actions” UI may be provided by UIM 401 or by agent UIs 134, 165. The screen may include a list of actions identified or performed 523 at the site (e.g., SA 450, SDS 400). A user may be able to scroll through the list using user interface elements 524, and may be able to modify the list using additional user interface elements 525. Each identified action in the action list 523 may have associated with it a number of action parameters 521. Examples of such action parameters include: action name; remedy action; action sub-type; action timeout time remaining; filename; file output; file static parameters; file dynamic parameters; etc. (see 529). A user may be able to modify parameters associated with an identified action using user interface elements 522. Additionally, a user may be able to view a “faults” UI and a “rules” UI using user interface elements 510 and 530, respectively.

With reference to FIG. 5C, a “rules” UI may be provided by UIM 401 or by agent UIs 134, 165. The screen may include a list of rules identified or implemented 534 at the site (e.g., SA 450, SDS 400). A user may be able to scroll through the list using user interface elements 535. Each identified rule in the rule list 534 may have associated with it a number of rule parameters 531. Examples of such rule parameters include: fault name; action name; priority; etc. (see 532). A user may be able to modify parameters associated with an identified rule using user interface elements 533. Additionally, a user may be able to view a “faults” UI and an “actions” UI using user interface elements 510 and 520, respectively.

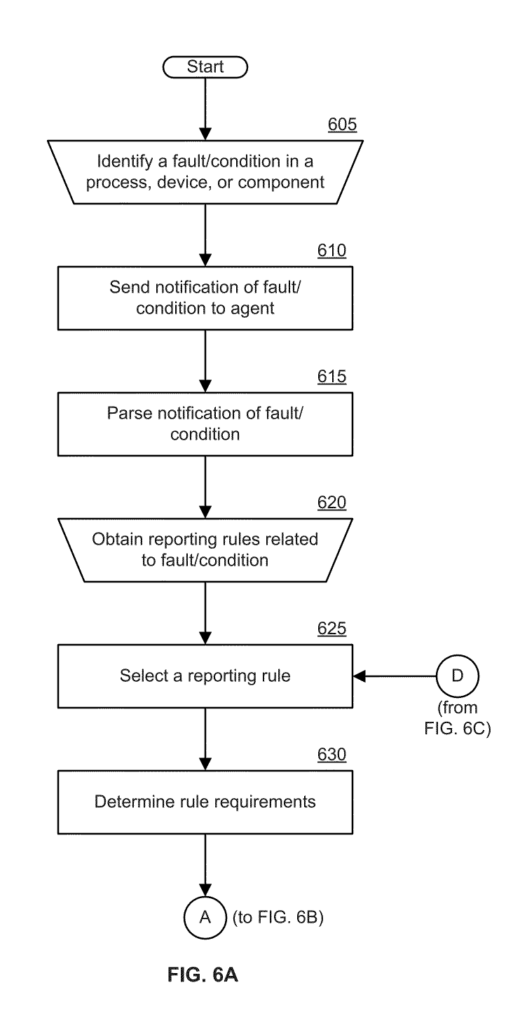

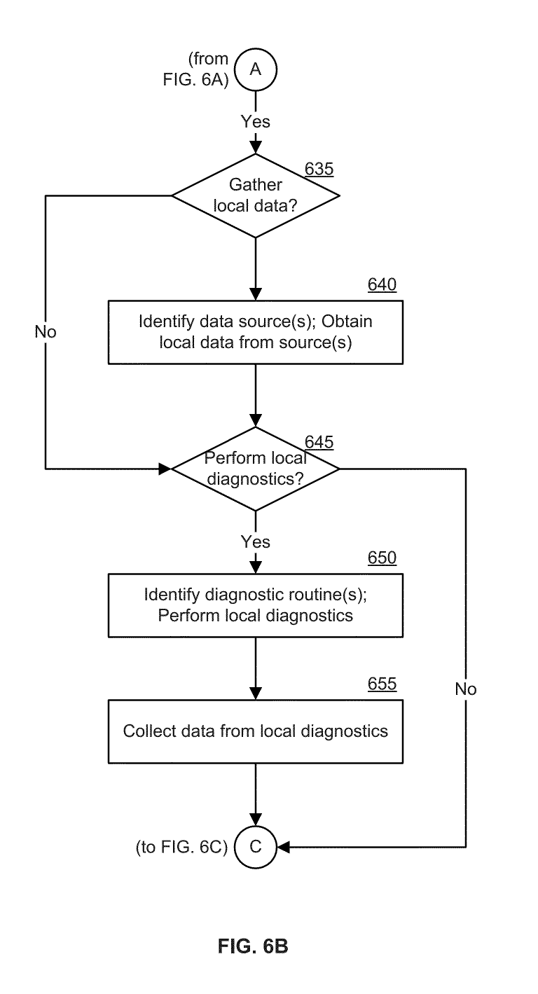

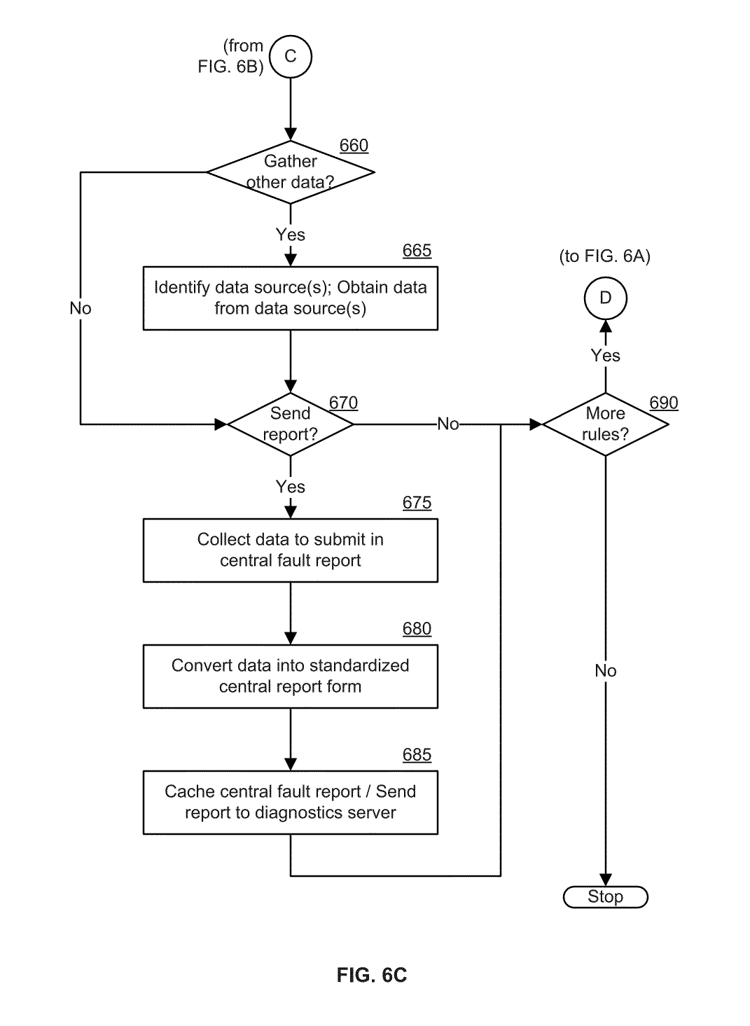

FIGS. 6A-C are flowcharts of a fault reporting procedure for smart service management. With reference to FIG. 6A, in some embodiments, at step 605, a node (e.g., an end-user device, network component, distributed process, etc.) may identify a fault or condition in a process, device, or component. At step 610, the node may send a notification of the fault or condition to an associated agent device or process (“agent”). At step 615, the agent may parse the notification of the fault or the condition. Using data extracted form the notification, at step 620, the agent may obtain reporting rules related to the fault or condition from a database. At step 625, the agent may select a reporting rule. At step 630, the agent may determine the rule's requirements for further processing.

With reference to FIG. 6B, at step 635, the agent may determine whether the rule requires that additional data be gathered to include in a central fault report to a diagnostics server. If so, at step 640, the agent may identify the source(s) of such data, send requests for such data, and obtain the local data from their sources. At step 645, the agent may determine whether any local diagnostics needs to be performed to generate additional data to be included in the central fault report. If so, at step 650, the agent may identify the local diagnostics routine(s), and performed the local diagnostics routine(s). For example, through such diagnostics routines, the agent may obtain additional data from the reporting node. Examples of such data collected include, without limitation: device firmware version, video error blocks, frame loss rate, media loss rate, sync loss, time since repair, macroblocks, video player restart count, device application crash count, local device restart time, out-of-memory exceptions, cache restart rate, stack overflow exceptions, distributed caching errors, etc. At step 655, the agent may collect the data from local diagnostics.

With reference to FIG. 6C, the agent may then determine, at step 660, whether to gather any additional data for inclusion in the central fault report. If so, at step 665, the agent may identify the sources of that data, and obtain the data from those sources. Once all the data and local diagnostics information is obtained, at step 670, the agent may make a determination as to whether to send a central fault report to the diagnostics server. If so, at step 675, the agent may collect the data to be submitted in the central fault report. At step 680, the agent may convert the data into standardized form. At step 685, the agent may cache the central fault report for transmission in an efficient manner to the diagnostics server, or may send the central fault report immediately. If any additional rules remain to be processed (see step 690), the agent may return flow control to step 625 (FIG. 6A) for further processing.

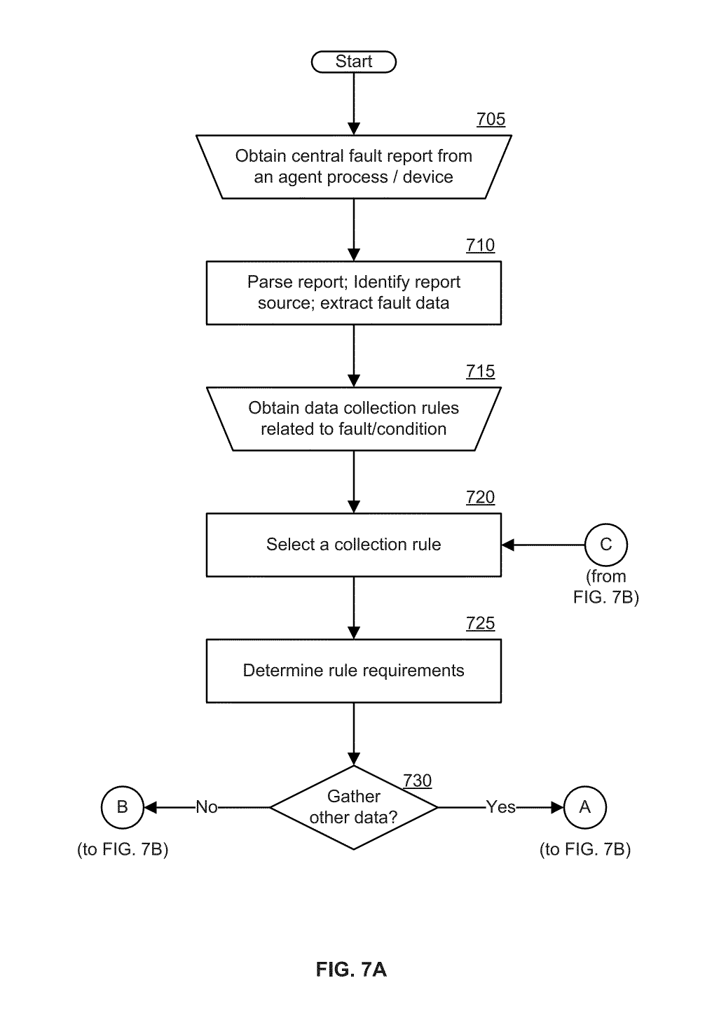

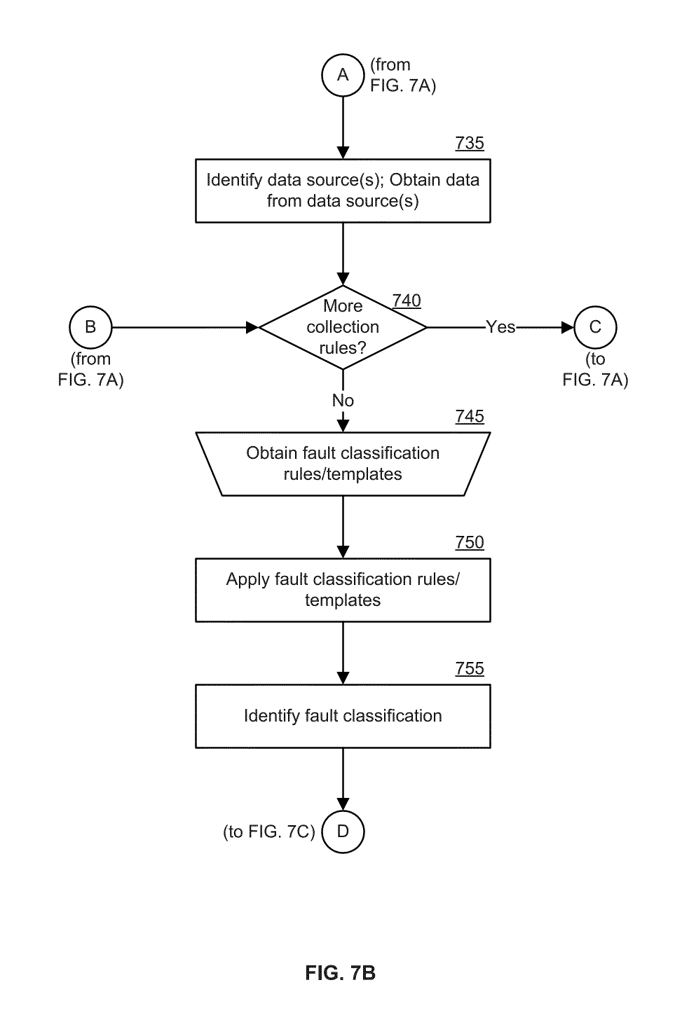

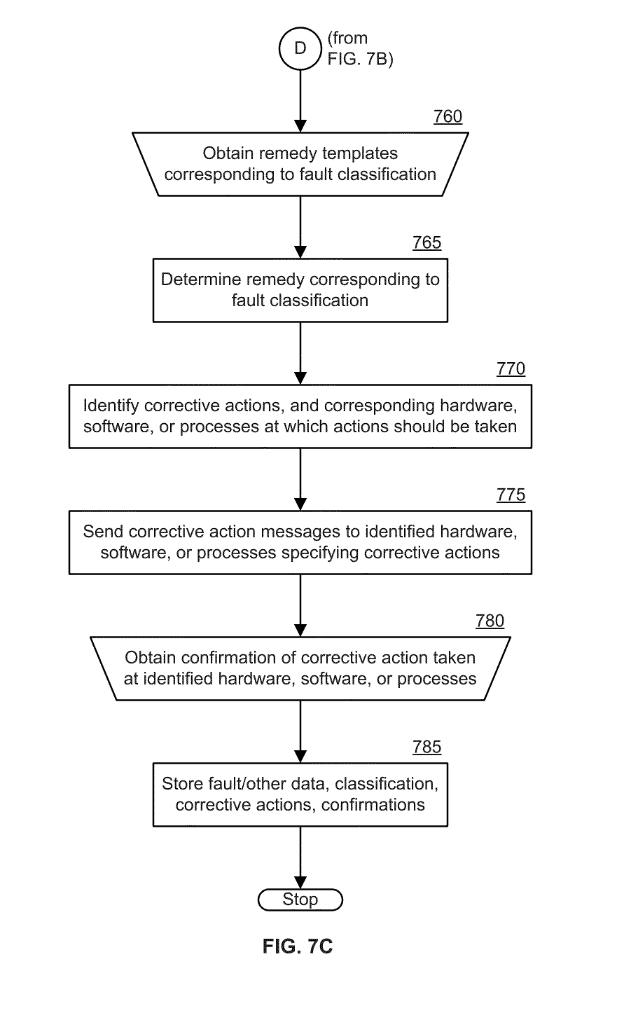

FIGS. 7A-C are flowcharts of a server-side fault remediation procedure for smart service management. With reference to FIG. 7A, at step 705, the diagnostics server may obtain the central fault report from the reporting agent. At step 710, the diagnostics server may parse the report, and identify the report source (e.g., agent, or the node that transmitted the fault notification to the agent in the first place). The diagnostics server may extract fault data included in the central fault report. At step 715, the diagnostics server may obtain data collection rules related to the fault or condition. At step 720, the diagnostics server may select a data collection rule for processing. At step 725, the diagnostics server may determine the rule requirements. At step 730, the diagnostics server may determine that other data should be collected.

With reference to FIG. 7B, at step 735, if so, at step 735, the diagnostics server may identify the data sources from which the other data should be collected, and may collect the data from those sources. At step 740, the diagnostics server may determine whether additional collection rules are to be processed. If so, the diagnostics server may return flow control to step 720 (FIG. 7A). At step 745, the diagnostics server may obtain fault classification rules/templates, and at step 750, may apply those rules/template to the available data. Thereby, at step 755, the diagnostic server may identify the fault classification. As part of classifying the fault, the diagnostic server may also identify one or more fault sub-classes, for example: system fault, subsystem fault, component fault, service fault, device fault, data fault, global fault, etc.

With reference to FIG. 7C, at step 760, the diagnostics server may obtain remedy rules/templates corresponding to the fault classification. At step 765, the diagnostics server may determine the remedy according to the fault classification. At step 770, the diagnostics server may identify corrective actions, and the corresponding hardware, software, data, or processes at which the corrective actions should be taken. At step 775, the diagnostics server may send corrective action messages to the identified hardware, software, or processes specifying the corrective actions. At step 780, the diagnostics server may obtain confirmation from the hardware, software, or processes that the corrective action has been taken. At step 785, the diagnostics server may store the fault data, other data, fault classification, corrective actions taken, and confirmation.

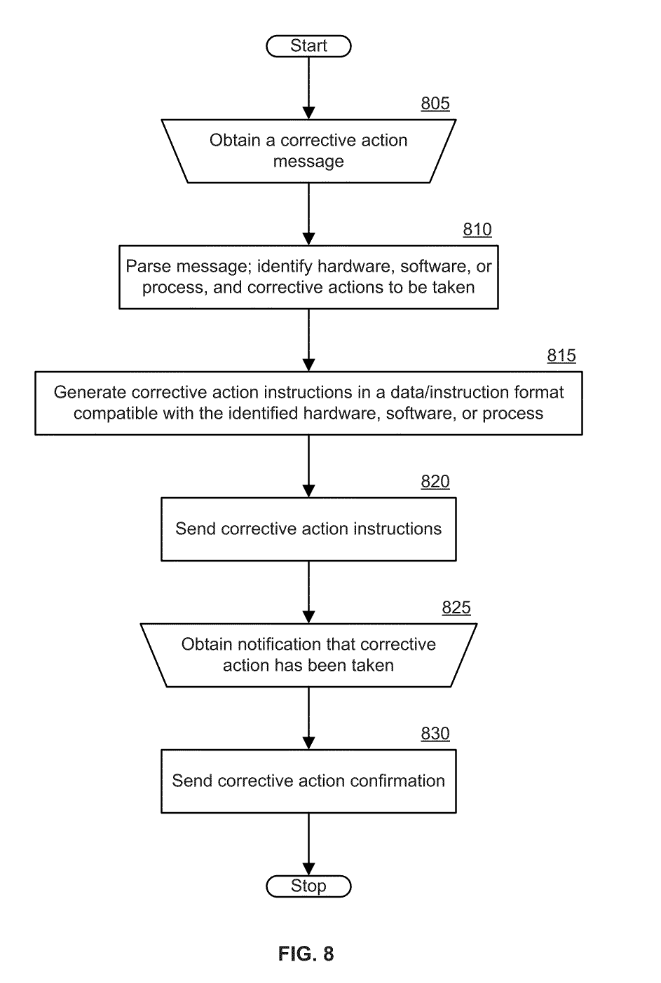

FIG. 8 is a flowchart of an agent-side fault remediation procedure for smart service management. At step 805, an agent may obtain a corrective action message from the diagnostics server. At step 810, the agent may parse the message, and identify the hardware, software, data, or processes for which corrective actions should be taken. The agent may also identify the corrective action to be taken from the message. At step 815, the agent may generate corrective action instructions encoded in a data/instruction format that is compatible with the identified hardware, software, or processes. At step 820, the agent may send the corrective action instructions. At step 825, the agent may obtain notification that the corrective action has been taken from the identified hardware, software, or processes. At step 830, the agent may generate and send a corrective action confirmation to the diagnostics server.

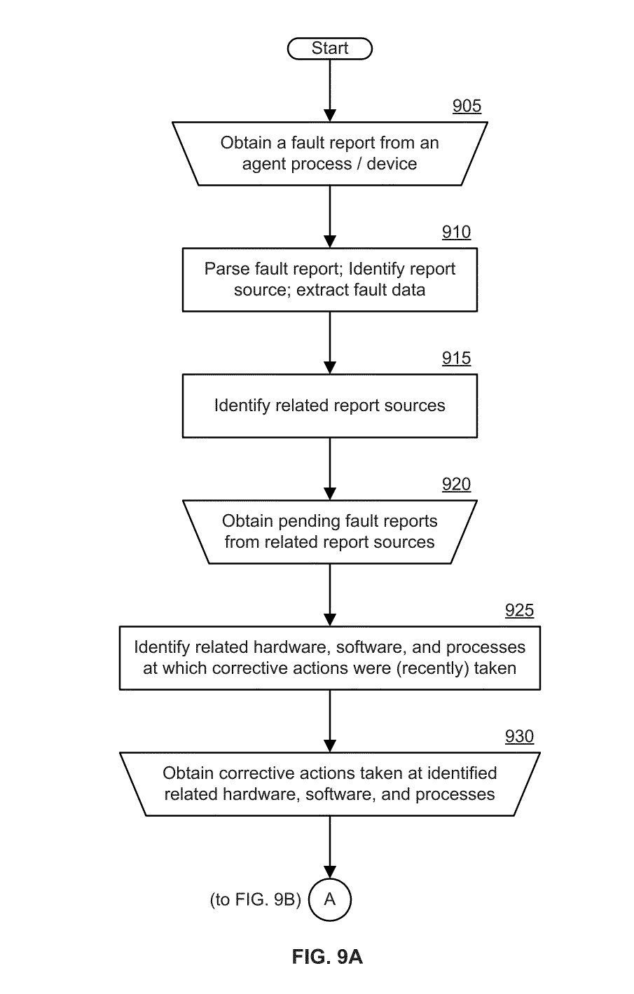

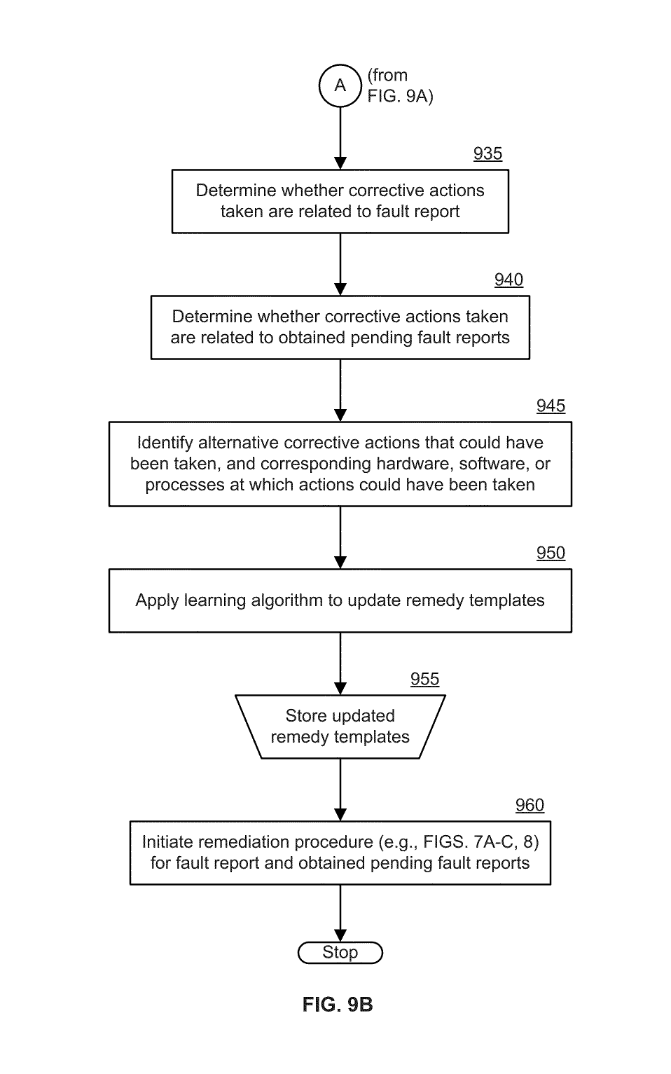

FIGS. 9A-B are flowcharts of a fault classification learning procedure for smart service management. With reference to FIG. 9A, at step 905, the diagnostics server may obtain a fault report from an agent process or agent device. At step 910, the diagnostics server may parse the fault report, and may extract the report source and fault data from the report. At step 915, the diagnostics server may identify related report sources, and at step 920, may obtain pending (e.g., not-yet-processed) fault reports from the related report sources. At step 925, the diagnostics server may identify the related hardware, software, and/or processes at which corrective actions were (recently) taken. At step 930, the diagnostics server may obtain the corrective actions that were taken at the identified hardware, software, and/or processes.

With reference to FIG. 9B, at step 935, the diagnostics server may determine whether the corrective actions taken at the identified hardware, software, and/or processes are related to the fault report from the agent process or agent device. At step 940, the diagnostics server may also determine whether the corrective actions taken at the identified hardware, software, and/or processes are related to the pending related fault reports. At step 945, the diagnostics server may identify alternative corrective actions that could have been taken, and corresponding hardware, software, and/or processes at which those alternative actions could have been taken. At step 950, the diagnostics server may apply a learning algorithm to update the rules/templates and/or remedies, based on the data obtained and alternative corrective actions identified. The learning algorithm adopted may be supervised (e.g., using decision trees, Bayesian methods, artificial neural networks, etc.), unsupervised (e.g., using clustering, dimensionality reduction, self-organizing maps, etc.), or a combination of both supervised and unsupervised (e.g., semi-supervised, committees, experts, etc.). At step 955, the diagnostics server may store the updated reedy rules/templates. At step 960, the diagnostics server may initiate a remediation procedure (e.g., as described above with reference to FIGS. 7A-C, 8) for the fault report and the pending related fault reports.

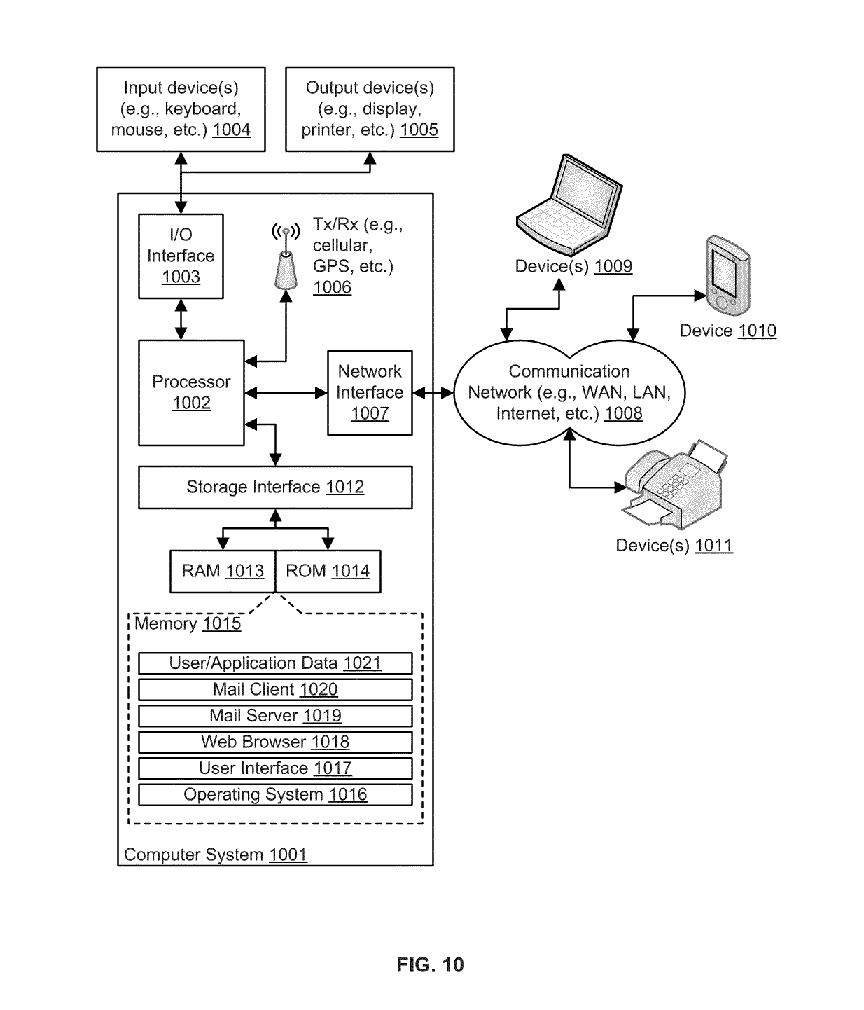

FIG. 10 is a block diagram of an exemplary computer system for implementing embodiments consistent with the present disclosure. Variations of computer system 1001 may be used for implementing the devices and systems presented in this disclosure. Computer system 1001 may comprise a central processing unit (“CPU” or “processor”) 1002. Processor 1002 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 1002 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1002 may be disposed in communication with one or more input/output (I/O) devices via I/O interface 1003. The I/O interface 1003 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 1003, the computer system 1001 may communicate with one or more I/O devices. For example, the input device 1004 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 1005 may be a printer, fax machine, video display (e.g., cathode ray tube (CRT), liquid crystal display (LCD), light-emitting diode (LED), plasma, or the like), audio speaker, etc. In some embodiments, a transceiver 1006 may be disposed in connection with the processor 1002. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 1002 may be disposed in communication with a communication network 1008 via a network interface 1007. The network interface 1007 may communicate with the communication network 1008. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1008 may include, without limitation, a direct interconnection, local area network (LAN), wide area network (WAN), wireless network (e.g., using Wireless Application Protocol), the Internet, etc. Using the network interface 1007 and the communication network 1008, the computer system 1001 may communicate with devices 1010, 1011, and 1012. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 1001 may itself embody one or more of these devices.

In some embodiments, the processor 1002 may be disposed in communication with one or more memory devices (e.g., RAM 1013, ROM 1014, etc.) via a storage interface 1012. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 1016, user interface application 1017, web browser 1018, mail server 1019, mail client 1020, user/application data 1021 (e.g., any data variables or data records discussed in this disclosure), etc. The operating system 1016 may facilitate resource management and operation of the computer system 1001. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 1017 may facilitate display, execution, interaction, manipulation, or operation of program components through textual or graphical facilities. For example, user interfaces may provide computer interaction interface elements on a display system operatively connected to the computer system 1001, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 1001 may implement a web browser 1018 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 1001 may implement a mail server 1019 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 1001 may implement a mail client 1020 stored program component. The mail client may be a mail viewing application, such as Apple Mail, Microsoft Entourage, Microsoft Outlook, Mozilla Thunderbird, etc.

In some embodiments, computer system 1001 may store user/application data 1021, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described systems and methods for smart service management in a media network. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A smart diagnostic system, comprising:
a hardware processor; and
a memory storing processor-executable instructions comprising instructions for:
receiving an agent fault report, including one or more network-wide standardized fault codes, from an agent application executing on a remote device in a media network;
aggregating one or more relevant fault reports related to the agent fault report;
obtaining one or more fault classification rules;
identifying one or more fault nodes and associated fault conditions in the media network using the one or more fault classification rules, by analyzing the aggregated relevant fault reports; and
providing an agent configuration instruction for one or more agent applications using the identification of the one or more fault nodes and associated fault conditions.

2. The system of claim 1, the instructions further comprising instructions for:
updating one or more of the fault classification rules based on a learning algorithm using one or more of: the agent fault report; the relevant fault reports; the determined one or more fault nodes; the one or more fault conditions; or the agent configuration instruction.

3. The system of claim 1, the instructions further comprising instructions for:
generating an updated map of fault conditions to agent configuration instructions.

4. The system of claim 1, the instructions further comprising instructions for:
displaying a user interface configured to provide fault statistics and agent configuration recommendations.

5. The system of claim 1, wherein the agent configuration instruction is based on one or more previously provided agent configuration instructions for one or more agent applications.

6. The system of claim 1, wherein the agent configuration instruction is provided to another agent application different from the agent application from which the agent fault report was received.

7. The system of claim 1, the instructions further comprising instructions for:
providing the agent application an instruction to query another agent application for information;
wherein the received agent fault report is based on the information.

8. The system of claim 1, wherein the agent fault report is received via one of: a pull mode or a push mode of communication.

9. A smart diagnostic method, comprising:
receiving an agent fault report, including one or more network-wide standardized fault codes, from an agent application executing on a remote device in a media network;
aggregating one or more relevant fault reports related to the agent fault report;
obtaining one or more fault classification rules;
identifying, via a hardware processor, one or more fault nodes and associated fault conditions in the media network using the one or more fault classification rules, by analyzing the aggregated relevant fault reports; and
providing an agent configuration instruction for one or more agent applications using the identification of the one or more fault nodes and associated fault conditions.

10. The method of claim 9, further comprising:
updating one or more of the fault classification rules based on a learning algorithm using one or more of: the agent fault report; the relevant fault reports; the determined one or more fault nodes; the one or more fault conditions; or the agent configuration instruction.

11. The method of claim 9, further comprising:
generating an updated map of fault conditions to agent configuration instructions.

12. The method of claim 9, further comprising:
displaying a user interface configured to provide fault statistics and agent configuration recommendations.

13. The method of claim 9, wherein the agent configuration instruction is based on one or more previously provided agent configuration instructions for one or more agent applications.

14. The method of claim 9, wherein the agent configuration instruction is provided to another agent application different from the agent application from which the agent fault report was received.

15. The method of claim 9, further comprising:
providing the agent application an instruction to query another agent application for information;
wherein the received agent fault report is based on the information.

16. The method of claim 9, wherein the agent fault report is received via one of: a pull mode or a push mode of communication.

17. A non-transitory computer-readable medium storing computer-executable smart diagnostic system instruction comprising instructions for:
receiving an agent fault report, including one or more network-wide standardized fault codes, from an agent application executing on a remote device in a media network;
aggregating one or more relevant fault reports related to the agent fault report;
obtaining one or more fault classification rules;
identifying one or more fault nodes and associated fault conditions in the media network using the one or more fault classification rules, by analyzing the aggregated relevant fault reports; and
providing an agent configuration instruction for one or more agent applications using the identification of the one or more fault nodes and associated fault conditions.

18. The medium of claim 17, the instructions further comprising instructions for:
updating one or more of the fault classification rules based on a learning algorithm using one or more of: the agent fault report; the relevant fault reports; the determined one or more fault nodes; the one or more fault conditions; or the agent configuration instruction.

19. The medium of claim 17, the instructions further comprising instructions for:
generating an updated map of fault conditions to agent configuration instructions.

20. The medium of claim 17, the instructions further comprising instructions for:
displaying a user interface configured to provide fault statistics and agent configuration recommendations.

21. The medium of claim 17, wherein the agent configuration instruction is based on one or more previously provided agent configuration instructions for one or more agent applications.

22. The medium of claim 17, wherein the agent configuration instruction is provided to another agent application different from the agent application from which the agent fault report was received.

23. The medium of claim 17, the instructions further comprising instructions for:
providing the agent application an instruction to query another agent application for information;
wherein the received agent fault report is based on the information.

24. The medium of claim 17, wherein the agent fault report is received via one of: a pull mode or a push mode of communication.
